(19) United States
(12) Patent Application Publication
(10) Pub. No.: US 2019/0251020 A1
(43) Pub. Date: Aug. 15, 2019

(54) SYSTEM AND METHOD FOR AUTOMATED SOFTWARE QUALITY ASSURANCE TESTING AND VISUAL REPORTING

(71) Applicants: Kabushiki Kaisha Toshiba, Minato-ku (JP); Toshiba TEC Kabushiki Kaisha, Shinagawa-ku (JP)

(72) Inventor: Zachary A. YEUNG, Mission Viejo, CA (US)

(21) Appl. No.: 15/892,815

(22) Filed: Feb. 9, 2018

(51) Int. Cl. G06F 11/36

(52) U.S. Cl. CPC G06F 11/3688; G06F 11/3664

(57) ABSTRACT

A system and method for automated software testing and display includes a processor, memory and a network interface. A plurality of software quality assurance test applications are stored and made available for use, along with schedule data corresponding to scheduled running of a series of software quality assurance test applications on a networked data device. A series of the plurality of quality assurance test applications on a networked data device is commenced in accordance with the schedule data. Test results are received from the networked data device in accordance with running of the quality assurance test applications. A graphical image corresponding to received test result data is generated for display.

### TECHNICAL FIELD

This application relates generally to software quality assurance testing. The application relates more particularly to scheduling, running and reporting of results from software quality assurance testing in a manner that is readily viewable and understandable by technicians.

### BACKGROUND

Document processing devices are example digital processing devices which include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs include an intelligent controller which is a computer directed to control document processing operations on the device, as well as other data processing and data communication functions. Like other computers, intelligent controllers have an operating system and one or more applications running them. Applications or operating systems are regularly updated, features are added and bug fixes are made. Any errors or inconsistences in coding can cause for significant issues to device end users, administrators and technicians.

### SUMMARY

In accordance with an example embodiment of the subject application, a system and method for automated software testing and display includes a processor, memory and a network interface. A plurality of software quality assurance test applications are stored and made available for use, along with schedule data corresponding to scheduled running of a series of software quality assurance test applications on a networked data device. A series of the plurality of quality assurance test applications on a networked data device is commenced in accordance with the schedule data. Test results are received from the networked data device in accordance with running of the quality assurance test applications. A graphical image corresponding to received test result data is generated for display.

### BRIEF DESCRIPTION OF THE DRAWINGS

Various embodiments will become better understood with regard to the following description, appended claims and accompanying drawings wherein:

FIG. 1 an example embodiment of an automated device software testing and reporting system;

FIG. 2 is an example embodiment of a networked digital device;

FIG. 3 is an example embodiment of a digital data processing device; and

FIG. 4 is a flowchart of an example embodiment of a system for accomplishing a completion and reporting of an automated testing sequence.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFPs have a wide array of complex functions that are managed or controlled by an on-board digital processing system referred to as a system controller, or simply a controller. Controller operation is managed by specialized software written to perform document processing device functions, such as copying, scanning, printing, e-mailing network operation, security systems and the like. New hardware features, such as adding an integrated hole puncher or stapler to an MFP requires corresponding software to be run on the controller to implement them. New or updated versions of controller software are generated routinely. Like any software, modification of controller code can cause bugs, glitches, performance issues, or the like. Software quality assurance testing for controller code provides valuable feedback to programmers to eliminate or minimize any such problems prior to release of code for new or existing WI's. Software quality assurance applications may advantageously be run on controllers themselves to provide for accurate results.

Software quality assurance (“SQA”) testing can include running of applications such as a “Smoke Test,” which is a cursory test that ensures the basic functionality of the application works. The primary outcome is validating that the build can be considered for further testing, and ultimately early problem detection. If a smoke test fails, there may be serious blocking issues that need to be addressed quickly. Early detection is important so that a larger group of people do not become blocked by installing a bad build.

Smoke tests may be:
Extremely fast to run;
Automated;
Run on every build, including interim builds generated throughout the day;
Focus only on critical functions (e.g. a user can login);
Shallow and wide (touch as many parts of an application under test as possible);
Small in number (i.e. one or a few smoke tests per build);
Typically built into other, more thorough, test cases; and
Executable in minutes (not hours).

BVTs, or Build Verification Tests (also called Build Acceptance Tests, or Sanity Tests), are a superset of smoke tests, but in some cases the terms are used interchangeably. BVTs may be top priority test cases that exercise basic functionality in the build, slightly more thoroughly than smoke tests. BVTs ensure that the daily build is usable for testing.

BVTs may be:
Run as part of the overall test pass (highest priority tests);
Typically automated;
Run immediately after a daily build is produced; and
Executable in minutes in minutes (not hours).

A BVT is suitably a set of tests run on every new build to verify that build is testable before it is released to the test team for further testing. These test cases are core functionality test cases that ensure one or more applications are stable and can be tested thoroughly. Typically, the BVT process is automated. If a BVT fails that build is suitably reassigned to a developer for the fix.

A BVT may include a type of regression testing, done on each and every new build. A BVT suitably checks for the project integrity and checks whether all the modules are integrated properly. Module integration testing is very important when different teams develop project modules. Many applications may fail due to improper module integration.

BVT was primarily introduced to check initial build health, including a check of whether all new or modified files are included in the release, all file formats are correct, every file version and language is correct, along with flags associated with each file. These basic checks are worth before build release to test team for testing.

By way of example, suitable test cases to be included in BVT for an example text editor application may include:
Test case for creating the text file;
Test cases for writing something into text editor;
Test case for copy, cut, paste functionality of text editor; and
Test case for opening, saving, deleting text file.

BVT automation suits need to be maintained and modified from time-to-time. By way of example, modifications may include test cases in BVT when there are new stable project modules available.

By way of further example, when BVT tests are run:
A result of BVT execution is suitably sent to all email ID's associated with the project;
The BVT owner (person executing and maintaining the BVT suite) inspects the result of BVT;
If a BVT fails then BVT owner diagnose the cause of failure;
If the failure cause is the defect in build, all relevant information with failure logs is sent to respective developers;
Developer in an initial diagnostic replies to their team about the failure cause, such as whether there is a bug, if so will be the bug-fixing scenario; and
After a bug fix, the BVT test suite is re-executed and if the build passes BVT, it is passed to test team for further detail functionality, performance, and other tests.

This process is suitably repeated for every new build. It should be noted that a BVT may itself have a bug at times. There can be other reasons for a build to fail such as a test case coding error, automation suite error, infrastructure error, hardware failures, etc.

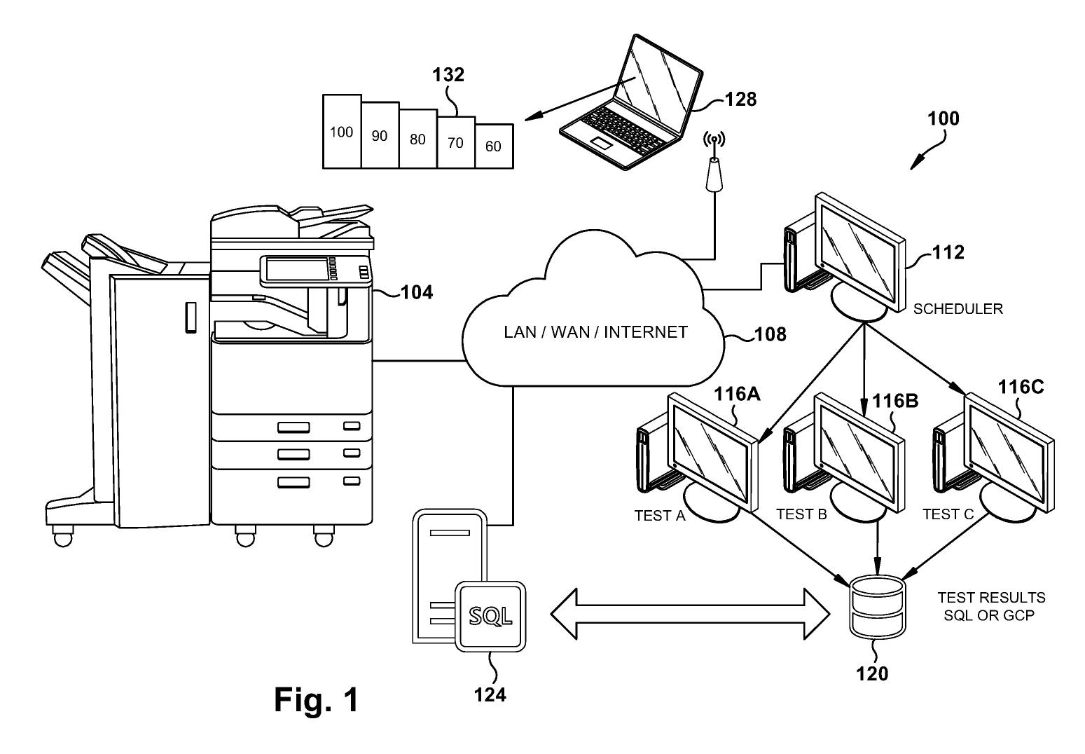

In accordance with the subject application, FIG. 1 illustrates an example embodiment of automated device software testing and reporting system 100. In the illustrated example, testing is suitably done on any suitable digital processing device, including but not limited to MFP 104. MFP 104 is suitably networked with cloud 108, suitably comprised of a local area network (LAN), a wide area network (WAN) which may comprise the Internet, or any suitable combination thereof. Testing is suitably choreographed by a scheduler device 112. A target device for testing, such as digital device 116A, 116B, or 116C (collectively digital devices 116), undergoes a series of one or more tests under the direction of scheduler 112. In the illustrated example, a sequence of tests is comprised of test A at 116A, test B and 116B and test C at 116C. Test results are suitably made available as they are completed. The related art below shows the interaction between a reviewer and a tester with the visualization tool. A tester, or a permitted user, can access the scheduler module to schedule certain SQA tests. These tests will then run and produce raw data results which will be stored in some storage manner (for example an SQL database or a cloud service). Any reviewer can then use the visualization web user interface to query certain test results that were produced during a certain time frame.

The automated device software testing and reporting system 100 enables testers and permitted users to schedule supported tests, such as SQA automation tests, through a web interface. This can accommodate situations such as when a user to forgets to schedule a test while enhancing accessibility such that results are not limited to just one user's scheduled tests. Raw data of the test results is suitably exposed to any reviewer who has access to a suitable web interface visualization tool. Such a tool provides a permitted user a way to query for certain test results, such as SQA test results, to show either raw data or “translated data.” Translated data refers to raw data translated into a simplified format for quick inference by reviewers such as graphs, histograms, or plots. This will allow for reviewers to quickly learn more patterns produced by test case results in order to create predictions for future runs or to spot outliers or abnormal behavior.

The afore-described functionality improves a situation wherein data is collected and translated solely upon a reviewer's request. This further improves on a process of reviewers having to request the testers for the results or having to wait until the results are ready. The subject functionality further enables users to schedule specific test cases at any time so in the case of a tester not being available, the tests can still be started.

With automated device software testing and reporting system 100, test results 120 can be suitably relayed as they are obtained to subscribing devices. Such relaying is suitably in real time, after completion of a test or set of tests, after completion of all tests, or any suitable combination thereof. Test results 120 are suitable sent to a network server, such as SQL cloud server 124. A suitable digital processing device, such as computer 128, generates a test report 132, suitably a graphical report, on an associated display. Such display may be real time, progress based or of a final, combined test report depending on a particular user's specification or need.

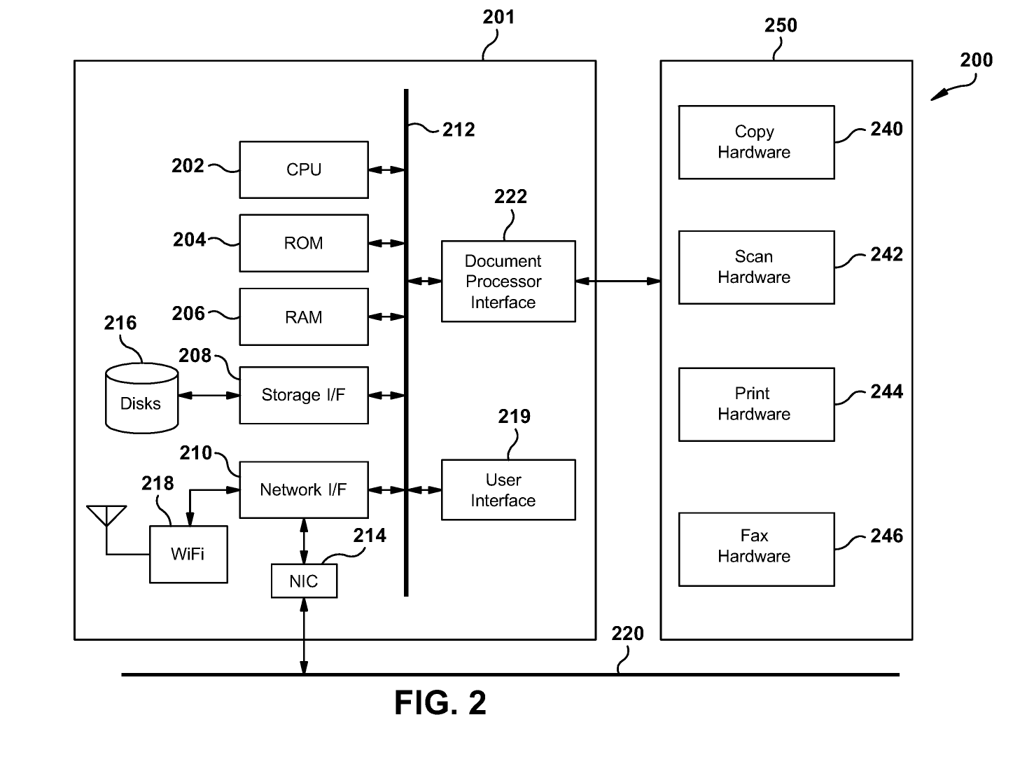

Turning now to FIG. 2 illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Thus, an MFP can itself function as a cloud server with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors which provide data relative to a state of the device or associated surroundings, such as device temperature, ambient temperature, humidity, device movement and the like. Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Controller 201 is suitably provided with an embedded web server system for device configuration and administration. A suitable web interface is comprised of TOPACCESS Controller (sometimes referred to in the subject illustrations as “TA”), available from Toshiba TEC Corporation.

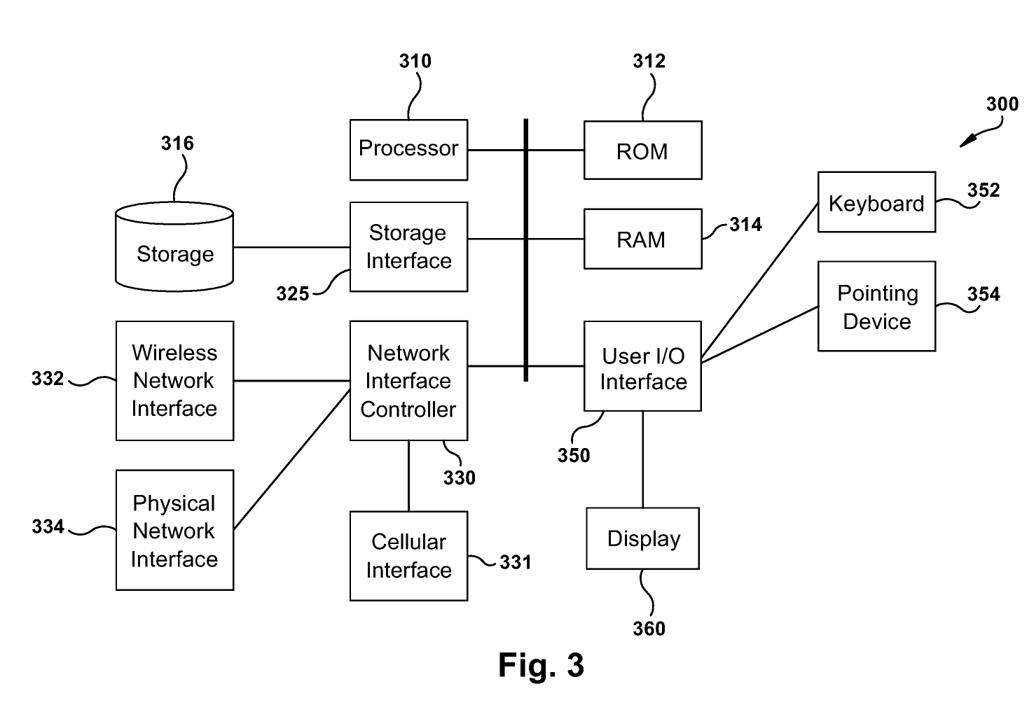

Turning now to FIG. 3, illustrated is an example embodiment of a digital data processing device 300, suitably comprising devices such as digital device 116, tablet computer 120, cloud server 124 or computer 128 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 231 such as when the digital device is a cell phone or tablet computer. A user input/output interface 350 suitably provides a gateway to devices such as keyboard 352, pointing device 354, and display 260, suitably comprised of a touch-screen display. It will be understood that the computational platform to realize the system as detailed further below is suitably implemented on any or all of devices as described above.

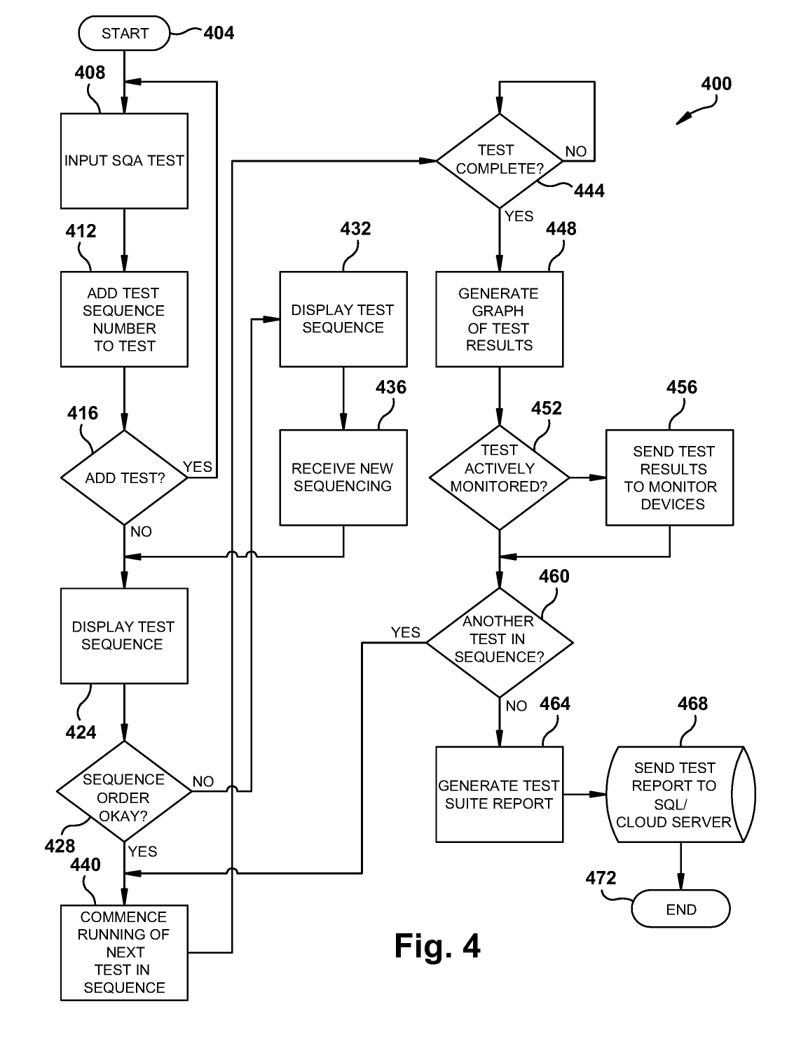

Referring next to FIG. 4, illustrated is a flowchart 400 of a system for accomplishing a completion and reporting of one or more tests in a given test sequence. The process commences at block 404, and a test, such as a SQA test, is suitably selected or input at block 408. A sequence number is added to the received test at block 412. If another test is to be added as determined at block 416, the process returns to block 408. If not, the test sequence is displayed at block 424. If this is determined to be an unacceptable ordering at block 428, the sequence is displayed at 432 for editing with user modifications received at block 436. The process then returns to block 424.

If the sequence is approved at block 428, the next test, which is an initial test in a sequence in this instance, is run at block 440. The process remains at block 444 until the test is complete, and results are suitably generated for graphical rendering at block 448. If a user as subscribed to monitor test results, as determined at block 452, results are reported at block 456.

A determination is made at block 460 as to whether another test remains in the scheduled sequence. If so, the process returns to block 440 and the next test in the sequence is run. When no further tests remain, a final test report is generated at block 464, and this is saved to a digital device, such as a cloud server, suitably a SQL server at block 468. The process then ends at block 472.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a network interface; and
a processor and associated memory,
the memory storing a plurality of software quality assurance test applications,
the memory further storing schedule data corresponding to scheduled running of a series of the plurality of software quality assurance test applications on a networked data device,
the processor configured to commence, via the network interface, running a series of the plurality of quality assurance test applications on the networked data device in accordance with the schedule data,
the network interface configured to receive test result data from the networked data device in accordance with running of the quality assurance test applications on the networked data device,
the processor further configured to generate graphical image data corresponding to received test result data, and
the processor further configured to communicate graphical image data to an associated display.

2. The system of claim 1 wherein the processor is further configured to update the graphical image data after completion of each of the series of quality assurance test applications.

3. The system of claim 1 wherein the processor is further configured to generate the graphical image data comprising a graph of the test result data.

4. The system of claim 3 wherein the processor is further configured to generate the graphical image data comprising a histogram of the test result data.

5. The system of claim 1 wherein the processor is further configured to generate the graphical image data responsive to a query received via the network interface.

6. The system of claim 5 wherein the processor is further configured to generate the graphical image data corresponding to test result data from one of the plurality of quality assurance test applications specified by the query.

7. The system of claim 1 wherein the processor is further configured to generate an alert to an associated user via the network interface after completion of at least one of the quality assurance test applications.

8. A method comprising:
storing a plurality of software quality assurance test applications in a memory;
storing, in the memory, schedule data corresponding to scheduled running of a series of the plurality of software quality assurance test applications on a networked data device;
commencing, via a processor and a network interface, running a series of the plurality of quality assurance test applications on the networked data device in accordance with the schedule data;
receiving into the memory test result data from the networked data device in accordance with running of the quality assurance test applications on the networked data device;
generating graphical image data corresponding to received test result data; and
communicating graphical image data to an associated display.

9. The method of claim 8 further comprising updating the graphical image data after completion of each of the series of quality assurance test applications.

10. The method of claim 8 further comprising generating the graphical image data comprising a graph of the test result data.

11. The method of claim 10 further comprising generating the graphical image data comprising a histogram of the test result data.

12. The method of claim 8 further comprising generating the graphical image data responsive to a query received via the network interface.

13. The method of claim 12 further comprising generating the graphical image data corresponding to test result data from one of the plurality of quality assurance test applications specified by the query.

14. The method of claim 8 further comprising generating an alert to an associated user via the network interface after completion of at least one of the quality assurance test applications.

15. A multifunction peripheral comprising:
an intelligent controller including a processor and a memory;
a document processing engine configured to be selectively operated by the intelligent controller; and
a network interface configured to
receive a plurality of software quality assurance test applications into the memory, and
receive test schedule data into the memory,
wherein the processor is further configured to process each of the plurality of software quality assurance test applications in accordance with received test schedule data,
wherein the processor is further configured to store, in the memory, test result data from running each of the plurality of software quality assurance test applications, and
wherein the processor is further configured to output the test result data to at least one networked data device via the network interface.

16. The multifunction peripheral of claim 15 wherein the processor is further configured to output the test result data to the at least one networked data device responsive to a query received via the network interface.

17. The multifunction peripheral of claim 15 wherein the processor is further configured to generate an alert to the at least one networked data device upon completion of one of the plurality of software quality assurance test applications.

18. The multifunction peripheral of claim 17 wherein the processor is further configured to generate graphical display data corresponding to the test result data, and
wherein the processor is further configured to output the graphical display data to the at least one networked data device.

19. The multifunction peripheral of claim 18 wherein the processor is further configured to generate the graphical display data comprising a graph of the test result data.

20. The multifunction peripheral of claim 19 wherein the processor is further configured to generate the graphical display data comprising a histogram of the test result data.
